(19) United States
(12) Patent Application Publication
(10) Pub. No.: US 2008/0166918 A1
(43) Pub. Date: Jul. 10, 2008

(54) Three-in-one connector set

(75) Inventors: Yun-Chang Yang, Taoyuan County (TW); Po-Cheng Lu, Taoyuan County (TW)

Correspondence Address: TROXELL LAW OFFICE PLLC, 5205 LEESBURG PIKE, SUITE 1404, FALLS CHURCH, VA, 22041, US

(73) Assignee: SPEED TECH CORP., Taoyuan County (TW)

(21) Appl. No.: 11/650,562

(22) Filed: Jan. 8, 2007

(51) Int. Cl. H01R 13/648

(52) U.S. Cl. 439/608

(57) ABSTRACT

A connector set integrates an RJ45 connector, a USB connector and an eSATA connector. A space occupied by the connectors is thus saved. And a connector for a new protocol eSATA is provided.

### FIELD OF THE INVENTION

The present invention relates to assembling connectors; more particularly, relates to integrating an RJ45 (Registered Jack 45) connector, a Universal Serial Bus (USB) connector and an external Serial Advanced Technology Attachment (eSATA) connector into a single structure to save space, to obtain hot-swapping, and to provide an increased transmission speed.

### DESCRIPTION OF THE RELATED ART(S)

A prior art comprises a USB connector, a Serial Advanced Technology Attachment (SATA) connector and an RJ45 connector, where the USB connector, the SATA connector and the RJ45 connector are set in a shell.

Another prior art is a multi-port connector supporting an RJ45, a USB and a SATA transmission interfaces, comprising an insulated base, a first connector module, a second connector module, a third connector module and a shielding shell, where the insulated base is a hollow container containing the first connector module, the second connector module and the third connector module; the first connector module is the RJ45 transmission interface; the second connector module is the USB transmission interface the third connector module is the SATA transmission interface; and the shielding shell is coated at outside of the insulated base.

Although the above two prior arts provide sockets for USB connectors and has sockets for SATA connectors for high-speed transmissions, modern requirements for transmission speed is getting crucial and a new protocol for high-speed transmission has appeared which is not covered by the above prior arts. Hence, the prior arts do not fulfill users' requests on actual use.

### SUMMARY OF THE INVENTION

The main purpose of the present invention is to integrate an RJ45 connector, a USB connector and an eSATA connector into a single structure to save space, to obtain hot-swapping, and to provide an increased transmission speed.

To achieve the above purpose, the present invention is a three-in-one connector set, comprising a substrate having a circuit board and a wave filter; a first connector of an RJ45 connector; a second connector together with a third connector separately being a USB connector and an eSATA connector; and a metal shell being coated at outside of the substrate, the first connector, the second connector and the third connector, where the first connector has a first shell, a first set of terminals and a set of external terminals; the first shell is fixed-on the circuit board and has a socket; the first set of terminals is set in the socket and is electrically connected with the circuit board; the set of external terminals is electrically connected with the circuit board and is connected with the substrate; the second connector together with the third connector has a second shell and a second set of terminals together with a third set of terminals; the second shell is fixed on the circuit board and has two socket; the second set of terminals together with the third set of terminals is separately set in the two sockets and is electrically connected with the circuit board and is connected with the substrate at an end; and the metal shell has openings corresponding to sockets for the first connector, the second connector, and the third connector. Accordingly, a novel three-in-one connector set is obtained.

### BRIEF DESCRIPTIONS OF THE DRAWINGS

The present invention will be better understood from the following detailed description of the preferred embodiment according to the present invention, taken in con junction with the accompanying drawings, in which

FIG. 1 is the front view showing the preferred embodiment according to the present invention;

FIG. 2 is the explosive view; and

FIG. 3 is the perspective view.

### DESCRIPTION OF THE PREFERRED EMBODIMENT

The following description of the preferred embodiment is provided to understand the features and the structures of the present invention.

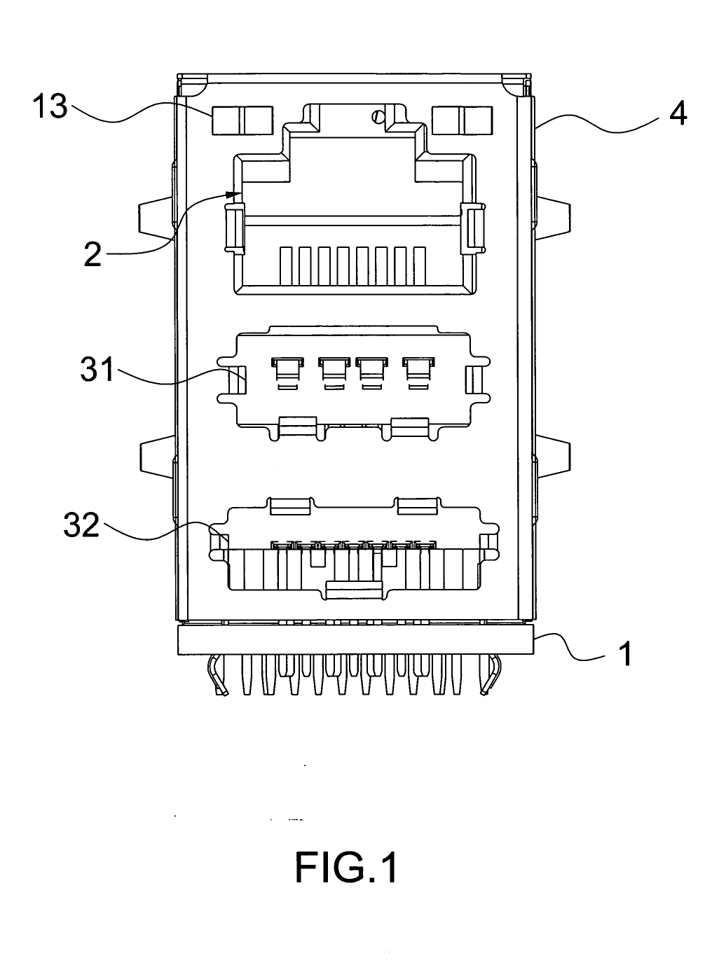

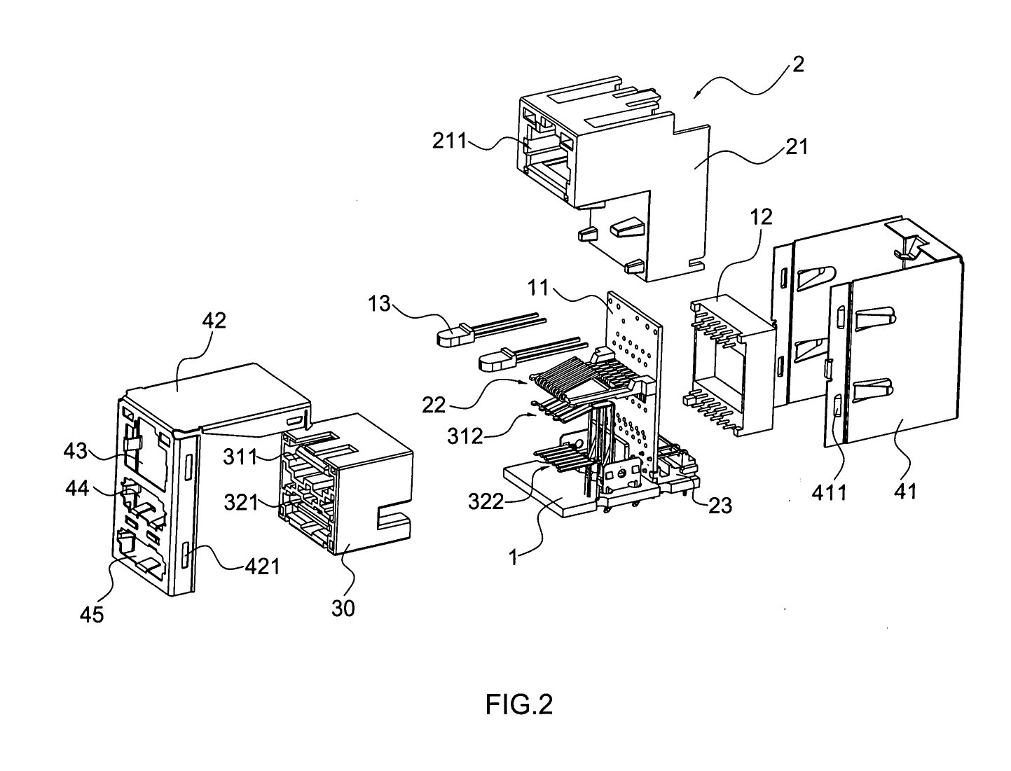

Please refer to FIG. 1 and FIG. 2, which are a front view and an explosive view showing a preferred embodiment according to the present invention. As shown in the figures, the present invention is a three-in-one connector set, comprising a substrate 1, a first connector 2, a second connector 31 together with a third connector 32, and a metal shell 4.

The substrate 1 has a circuit board 11, where the circuit board 11 has a wave filter 12 and an indicator 13.

The first connector 2 has a first shell 21, a first set of terminals 22 and a set of external terminals 23, where the first shell 21 is fixed on the circuit board 11 and has a socket 211; the first set of terminals 22 is set in the socket 211 and is electrically connected with the circuit board 11; the set of external terminals 23 is electrically connected with the circuit board 11 and is connected with the substrate 1; and the first connector 2 is an RJ45 (Registered Jack 45) network connector.

The second connector 31 together with the third connector 32 has a second shell 30 and a second set of terminals 312 together with a third set of terminals 322, where the second shell 30 is fixed on the circuit board 11 and has two sockets 311,321; the second set of terminals 312 together with the third set of terminals 322 is separately set in the two sockets 311,321 and is electrically connected with the circuit board 11 and is connected with the substrate 1 at an end; and the second connector 31 together with the third connector 32 is separately a Universal Serial Bus (USB) connector and an external Serial Advanced Technology Attachment (eSATA) connector. Therein, the second connector 31 is piled up on the third connector 32; or, on the contrary, the third connector 32 is piled up on the second connector 31 (not shown in the figures).

The metal shell 4 comprises two shells 41,42, where the shells 41,42 have a plurality of buckle loops 411 and a plurality of corresponding fixing holes 421; the metal shell 4 is coated at outside of the substrate 1, the first connector 2, the second connector 31 and the third connector 32; the metal shell 4 has an end surface having openings 43,44,45 separately corresponding to the sockets 211,311,321 of the first connector 2, the second connector 31 and the third connector 32; and the indicator 13 is set on an end surface of the metal shell 4 near the first connector 2.

Thus, an RJ45 connector, a USB connector and an eSATA connector are integrated to obtain a novel three-in-one connector set with occupied space saved.

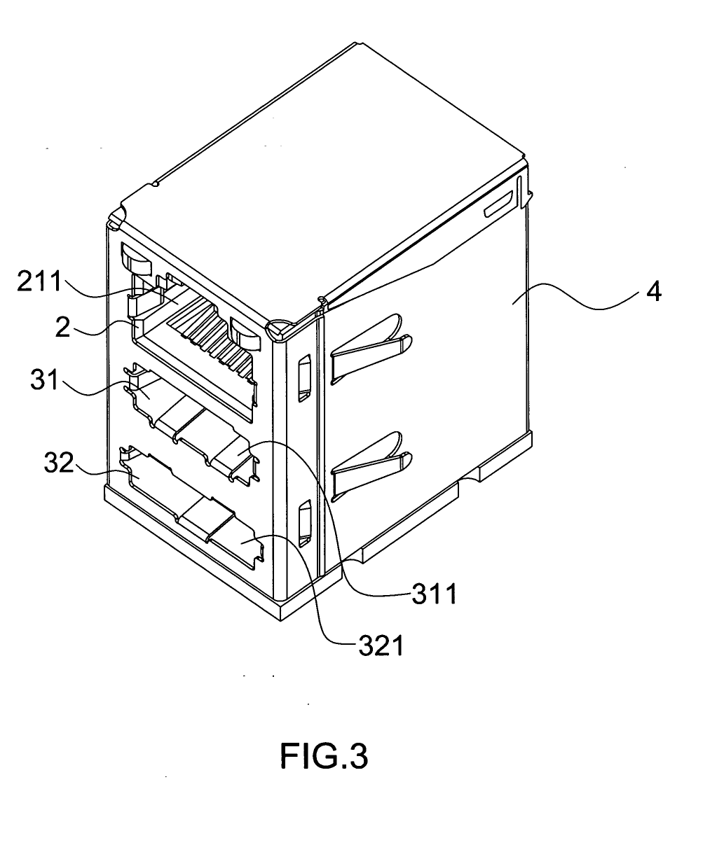

Please refer to FIG. 3, which is a perspective view showing the preferred embodiment. As shown in the figure, on assembling the present invention, a set of external terminals 23, a second set of terminals 312 and a third set of terminals 322, which are extended out of the substrate 1 on a first, a second and a third connectors 2,31,32, are correspondingly set on a circuit-board of a computer main frame (not shown in the figure). The sockets 211,311,321 set for the first, the second and the third connectors 2,31,32 are corresponding to a front plate or a rear plate of the computer mainframe (not shown in the figure). Thus, through using the sockets 211,311,321 for the first, the second and the third connectors 2,31,32, coordinated with the first set, the second set and the third set of terminals 22,312,322, outside plug is hot-swapped. And the third connector 32 as an eSATA connector is used to accelerate a transmission speed.

To sum up, the present invention is a three-in-one connector set, where an RJ45 connector, a USB connector and an eSATA connector are integrated to obtain a novel three-in-one connector set with occupied space saved; outside plug is hot-swapped; and a transmission speed is accelerated.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. A three-in-one connector set, comprising:
a substrate, said substrate having a circuit board, said circuit board having a wave filter;
a first connector, said first connector having a first shell, a first set of terminals, and a set of external terminals, said first shell being deposed on said circuit board and having a socket, said first set of terminals being located in said socket and being electrically connected with said circuit board, said set of external terminals being electrically connected with said circuit board and being connected with said substrate, said first connector being an RJ45 (Registered Jack 45) network connector;
a second connector together with a third connector, said second connector together with said third connector comprising a second shell and a second set of terminals together with a third set of terminals, aid second shell being deposed on said circuit board and having two sockets, said second set of terminals together with said third set of terminals being separately located in said two sockets and being connected with said circuit board and having an end connected with said substrate, said second set of terminals together with said third set of terminals being separately a universal serial bus (USB) connector and an external serial advanced technology attachment (eSATA) connector; and
a metal shell, said metal shell being coated at outside of said substrate, said first connector, said second connector and said third connector, said metal shell having an end surface having openings separately corresponding to said sockets of said first connector, said second connector and said third connector.

2. The connector according to claim 1,
wherein said circuit board has an indicator.

3. The connector according to claim 1,
wherein said second connector is piled up on said third connector.

4. The connector according to claim 1,
wherein said third connector is piled up on said second connector.

5. The connector according to claim 1,
wherein said metal shell comprises two shells; and
wherein said shells separately have a plurality of buckle loops and a plurality of corresponding fixing holes.
